(19) United States
(12) Patent Application Publication
(10) Pub. No.: US 2006/0027623 A1
(43) Pub. Date: Feb. 9, 2006

(54) Bonding structure, wire bonding method, actuator device and liquid jet head

(75) Inventor: Isao Yanagisawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/195,866

(22) Filed: Aug. 3, 2005

(30) Foreign Application Priority Data
Aug. 5, 2004 (JP) 2004-228877

(51) Int. Cl. B23K 37/00; B23K 31/02

(52) U.S. Cl. 228/4.5; 228/180.5

(57) ABSTRACT

A bonding structure and a wire bonding method, which can increase bonding strength and decrease the width and pitch of bonding pads, an actuator device and a liquid-jet head adopting the bonding structure are provided. A bonding site where a bonding wire is connected to the bonding pad is composed of a first connection site on a front end side, and a second connection site continuous with the first connection site. Wire bonding at a relatively low temperature compared with an ordinary wire bonding temperature of 150° C., is still capable of increasing bonding strength between the bonding wire and a terminal portion. Thus, the stitch width of the bonding wire connected to the terminal portion can be narrowed, the width of the terminal portion can be narrowed, and the pitch between the terminal portion and the adjacent terminal portion can be decreased.

### BACKGROUND OF THE INVENTION

1. Field of the Invention

This invention relates to a bonding structure involving a bonding wire connected to a bonding pad, and a wire bonding method for constructing such a bonding structure. More particularly, the invention relates to those which are preferred for application to an actuator device equipped with a vibration plate and piezoelectric elements, especially, for application to a liquid-jet head where a portion of a pressure generating chamber communicating with a nozzle orifice for ejecting ink droplets is constituted of the vibration plate, the piezoelectric elements are formed on the surface of the vibration plate, and ink droplets are ejected by displacement of a piezoelectric layer.

2. Description of the Related Art

An actuator device equipped with piezoelectric elements displaced by application of a voltage is installed, for example, on a liquid-jet head for jetting liquid droplets. Known as such a liquid-jet head is, for example, an ink-jet recording head in which a portion of a pressure generating chamber communicating with a nozzle orifice is constituted of a vibration plate, and the vibration plate is deformed by a piezoelectric element to pressurize ink in the pressure generating chamber, thereby ejecting ink droplets from the nozzle orifice. Two types of ink-jet recording heads are put into practical use. One of them is mounted with a piezoelectric actuator device of longitudinal vibration mode which expands and contracts in the axial direction of the piezoelectric element. The other is mounted with a piezoelectric actuator device of flexural vibration mode.

The latter ink-jet recording head adopts a structure in which a drive IC is installed on a plate bonded to a passage-forming substrate having the pressure generating chamber formed therein, for example, a reservoir forming plate, and the drive IC and a terminal portion of a lead electrode leading from each piezoelectric element are electrically connected by a bonding wire by means of wire bonding (see, for example, Japanese Patent Application Laid-Open No. 2002-160366 (page 3, FIG. 2)). Wire bonding, which is performed in the production of such an ink-jet recording head, is carried out by connecting one end of a bonding wire to a terminal portion of the drive IC with the use of a capillary, and then connecting the other end of the bonding wire to a bonding pad, which is a terminal portion of the lead electrode, with the use of the capillary.

Generally, wire bonding is performed with heating at a temperature of 150° C. or higher, thus posing the problem that heating at such a high temperature thermally expands the respective plates constituting the ink-jet recording head until they are destroyed. Wire bonding in the ink-jet recording head, therefore, needs to be performed with heating at as low a temperature as possible. Wire bonding carried out with heating at a low temperature, however, presents the problem that adequate bonding strength between the bonding wire and the bonding pad cannot be secured.

Moreover, a high density is required of wiring for devices using bonding wires, which are typified by ink-jet recording heads. With ordinary wire bonding, however, bonding wires are pressed against bonding pads under a load of 294 to 882×10⁻³ N for connection. Thus, the bonding site (stitch zone) of the bonding wire connected to the bonding pad is formed with a stitch width 2 to 3 times the diameter of the wire, and a stitch thickness 0.1 times or less the wire diameter. Hence, the bonding pad has to be formed in a size larger than the width of the stitch zone, thus posing the problem that the width and pitch of the bonding pads cannot be decreased to achieve a high density. In this view, a proposal has been made for an electrode structure for wire bonding in which a concavity or a convexity is provided in the wire bonding area of the electrode on the substrate to provide a pressure bonding dimension of the bonding wire forcibly, thereby ensuring bonding strength and decreasing the width and pitch of the electrode (see, for example, Japanese Patent Application Laid-Open No. 1993-251856 (pages 2 to 3, FIG. 1)).

According to this laid-open document, however, bonding strength comparable to that of the conventional bonding wire can be secured, but only the pressure bonding dimension is forcibly provided, still posing the problem that bonding strength cannot be increased. The laid-open document also requires processing for providing the concavity or convexity in the bonding wire area of the electrode, and thus involves the problems of a complicated manufacturing process and a high manufacturing cost. These problems are true not only of liquid-jet heads such as ink-jet recording heads, but also devices having a bonding wire connecting structure using semiconductor elements such as LSI and IC.

Wire bonding involves the following steps: A bonding wire is pressed against a bonding pad by a capillary to connect the bonding wire to the bonding pad. With the bonding wire in a non-restraint state, the capillary is raised to create a state where the bonding is not paid off by a predetermined amount. Then, the bonding wire is brought into a restraint state and, in this state, the capillary is further raised, and pressed against the bonding wire to rupture its thin-walled site. Then, the capillary bearing the bonding wire paid off by the predetermined amount is moved to a next bonding zone to do bonding work.

Japanese Patent Application Laid-Open Nos. 2000-252315 and 1993-129357, for example, propose that the strength of a bonding zone can be secured by creating bumps from balls or performing ball bonding. However, these techniques both involve a single bonding operation and, thus, have been unable to improve bonding strength in a low temperature condition.

In wire bonding performed with heating at a low temperature, thermal energy is so low that the amplitude of ultrasonic waves is increased to compensate for the low thermal energy, thereby using thermal energy due to friction. On this occasion, the bonding zone may rupture owing to the amplitude, at a time when the bonding wire is pressed against the bonding pad by the capillary to bond it. If rupture occurs in the bonding zone, discharge by a torch may be impossible, resulting in inadequate bonding. If the bonding zone ruptures when the bonding wire is pressed against the bonding pad by the capillary, the bonding wire has not been paid off by a predetermined amount from the front end of the capillary, so that an operation for paying out the bonding wire manually becomes necessary for next bonding.

### SUMMARY OF THE INVENTION

The present invention has been accomplished in the light of the above-mentioned problems. It is an object of the present invention to provide a bonding structure and a wire bonding method which enable bonding strength to be increased even in the case of wire bonding performed with heating at a low temperature.

It is another object of the present invention to provide an actuator device and a liquid-jet head adopting a bonding structure which enables bonding strength to be increased even in the case of wire bonding performed with heating at a low temperature.

A first aspect of the present invention for attaining the above object is a bonding structure comprising: a bonding wire; a bonding pad; and a bonding site where the bonding wire is connected to the bonding pad, and wherein the bonding site is composed of a first connection site on a front end side, and a second connection site continuous with the first connection site.

In the first aspect, wire bonding at a relatively low temperature, compared with an ordinary wire bonding temperature of 150° C., is still capable of increasing bonding strength between the bonding wire and the bonding pad, because the bonding site is composed of the first connection site, and the second connection site continuous with the first connection site. Since the bonding strength can be increased, the stitch width of the bonding wire connected to the bonding pad can be narrowed, the width of the bonding pad can be narrowed, and the pitch between the bonding pad and the adjacent bonding pad can be decreased.

A second aspect of the present invention is the bonding structure according to the first aspect, characterized in that the second connection site has a high tensile strength as compared with the first connection site.

In the second aspect, wire bonding at a relatively low temperature, compared with an ordinary wire bonding temperature of 150° C., is still capable of increasing bonding strength between the bonding wire and the bonding pad, because the second connection site has a high tensile strength.

A third aspect of the present invention is the bonding structure according to the first aspect, characterized in that the second connection site is connected by applying ultrasonic waves of a large amplitude to the second connection site as compared with the first connection site.

In the third aspect, wire bonding at a relatively low temperature, compared with an ordinary wire bonding temperature of 150° C., is still capable of increasing bonding strength between the bonding wire and the bonding pad, because the second connection site is connected upon application of ultrasonic waves of a large amplitude.

A fourth aspect of the present invention is the bonding structure according to the first aspect, characterized in that a stitch width of the second connection site is rendered large as compared with a stitch width of the first connection site.

In the fourth aspect, wire bonding at a relatively low temperature, compared with an ordinary wire bonding temperature of 150° C., is still capable of increasing bonding strength between the bonding wire and the bonding pad, because the stitch width of the second connection site is rendered large.

A fifth aspect of the present invention is the bonding structure according to the first aspect, characterized in that a thickness of the second connection site is rendered small as compared with a thickness of the first connection site.

In the fifth aspect, wire bonding at a relatively low temperature, compared with an ordinary wire bonding temperature of 150° C., is still capable of increasing bonding strength between the bonding wire and the bonding pad, because the thickness of the second connection site is rendered small, namely, bonding for the second connection site is firm and under goes minimal peeling.

A sixth aspect of the present invention is the bonding structure according to the first aspect, characterized in that at least a surface of the bonding pad connected to the bonding wire comprises gold.

In the sixth aspect, the bonding pad comprising gold is used, so that the bonding wires comprising gold can be bonded reliably, and its bonding strength can be increased.

A seventh aspect of the present invention is a wire bonding method for connecting a bonding wire to a bonding pad, comprising the steps of: pressing a capillary against the bonding pad, while heating the bonding wire and applying ultrasonic waves, to connect the bonding wire to the bonding pad, thereby forming a first connection site; and pressing a tool against the bonding pad at a site continuous with the first connection site, while heating the bonding wire and applying ultrasonic waves, to connect the bonding wire to the bonding pad, thereby forming a second connection site.

In the seventh aspect, wire bonding at a relatively low temperature, compared with an ordinary wire bonding temperature of 150° C., is still capable of increasing bonding strength between the bonding wire and the bonding pad, because the bonding site is composed of the first connection site, and the second connection site continuous with the first connection site. Since the bonding strength can be increased, the stitch width of the bonding wire connected to the bonding pad can be narrowed, the width of the bonding pad can be narrowed, and the pitch between the bonding pad and the adjacent bonding pad can be decreased.

An eighth aspect of the present invention is the wire bonding method according to the seventh aspect, characterized by applying ultrasonic waves of a large amplitude at the second connection site as compared with the first connection site.

In the eighth aspect, wire bonding at a relatively low temperature, compared with an ordinary wire bonding temperature of 150° C., is still capable of increasing bonding strength between the bonding wire and the bonding pad, because the second connection site is bonded upon application of ultrasonic waves of a large amplitude.

A ninth aspect of the present invention is the wire bonding method according to the seventh aspect, characterized in that the tool is the capillary through which the bonding wire has not been inserted.

In the ninth aspect, the single capillary can form the first connection site and the second connection site.

A tenth aspect of the present invention is an actuator device comprising: a vibration plate provided on a surface of a substrate; a plurality of piezoelectric elements each composed of a lower electrode, a piezoelectric layer, and an upper electrode provided via the vibration plate; and bonding pads electrically connected to the piezoelectric elements, and having bonding wires connected thereto, and wherein the bonding wires are connected to the bonding pads by the bonding structure of any one of the first to fifth aspects.

In the tenth aspect, wire bonding at a relatively low temperature, compared with an ordinary wire bonding temperature of 150° C., still achieves an actuator device having a bonding structure capable of increasing bonding strength between the bonding wire and the bonding pad.

An eleventh aspect of the present invention is the actuator device according to the tenth aspect, including lead-out wirings leading from the piezoelectric elements, and characterized in that front end portions of the lead-out wirings define the bonding pads.

In the eleventh aspect, the lead-out wirings connected to the bonding wires can be provided at high density without short-circuiting, and the piezoelectric elements can be disposed at high density.

A twelfth aspect of the present invention is the actuator device according to the tenth aspect, characterized in that each of the bonding wires has one end connected to a terminal portion of a drive IC for driving the piezoelectric elements, and has another end connected to the bonding pad.

In the twelfth aspect, the bonding wire can be bonded with high strength to the bonding pad located on the second bonding side, and the stitch width of the bonding wire can be narrowed.

A thirteenth aspect of the present invention is a liquid-jet head comprising: the actuator device of any one of the tenth to twelfth aspects; and a passage-forming substrate in which pressure generating chambers communicating with nozzle orifices are formed, and on a surface of which the actuator device is provided.

In the thirteenth aspect, the bonding strength between the drive IC and other bonding pads can be increased, the width of the bonding pads can be narrowed, and the nozzle orifices can be arranged at high density.

### BRIEF DESCRIPTION OF THE DRAWINGS

For a more complete understanding of the present invention and the advantages thereof, reference is now made to the following descriptions in conjunction with the accompanying drawings.

FIG. 1 is an exploded perspective view of a liquid-jet head according to an embodiment of the present invention.

FIGS. 2A and 2B are, respectively, a plan view and a sectional view of the liquid-jet head according to the embodiment of the present invention.

FIG. 3 is a perspective view showing a connecting structure in wire bonding according to the present invention.

FIGS. 4A and 4B are sectional views of essential parts of the liquid-jet head, showing a wire bonding method according to the embodiment of the present invention.

FIGS. 5A and 5B are explanation drawings of steps in the wire bonding method.

FIGS. 6A and 6B are external views of connection sites of a bonding wire.

FIG. 7 is a graph showing the results of tests on wire bonding according to the present invention.

### DESCRIPTION OF THE PREFERRED EMBODIMENTS

The present invention will now be described in detail based on the embodiments offered below.

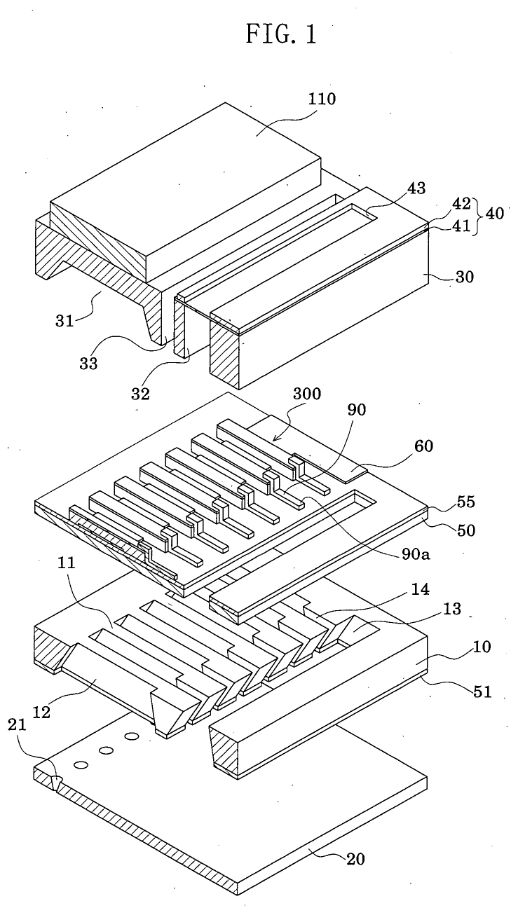

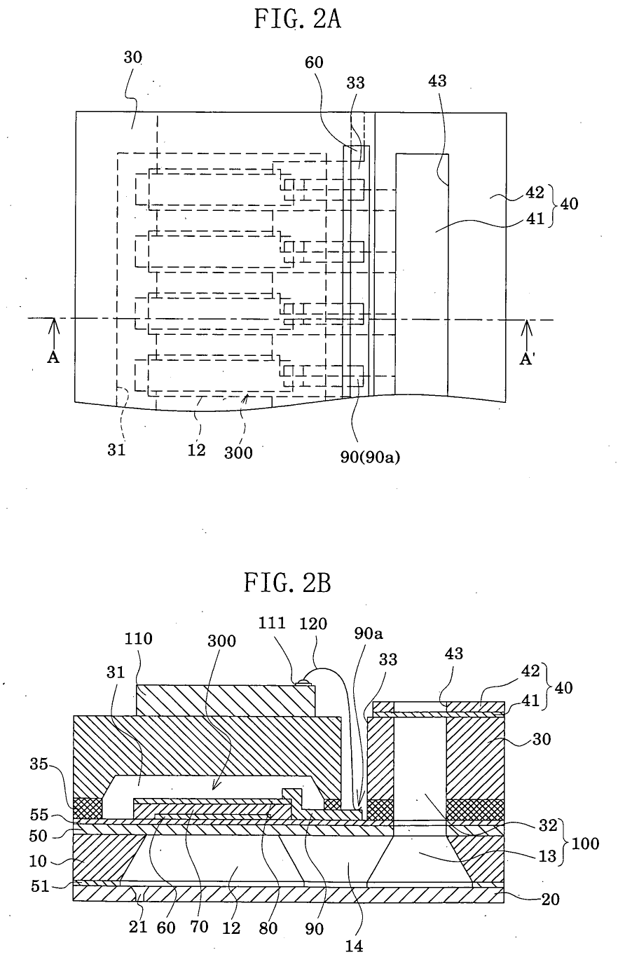

FIG. 1 is an exploded perspective view showing a liquid-jet head according to an embodiment of the present invention. FIG. 2A and FIG. 2B are a plan view and a sectional view, respectively, of the liquid-jet head in FIG. 1. A passage-forming substrate 10 constituting a liquid-jet head, in the present embodiment, consists of a single crystal silicon substrate. An elastic film 50, composed of silicon dioxide formed beforehand by thermal oxidation, is formed on one surface of the passage-forming substrate 10. In the passage-forming substrate 10, pressure generating chambers 12 partitioned by a plurality of compartment walls 11 are formed by anisotropic etching performed on the other surface of the passage-forming substrate 10. Longitudinally outwardly of the pressure generating chambers 12 arranged in a row, a communicating portion 13 is formed which communicates with a reservoir portion 32 provided in a reservoir forming plate 30 (to be described later on) to constitute a reservoir 100 serving as a common liquid chamber for the respective pressure generating chambers 12. The communicating portion 13 is also in communication with one end portion in the longitudinal direction of each pressure generating chamber 12 via a liquid supply path 14. Onto the opening surface of the passage-forming substrate 10, a nozzle plate 20 having nozzle orifices 21 bored therein is secured via an adhesive agent or a heat sealing film. The nozzle orifices 21 communicate with the pressure generating chambers 12 on the side opposite to the liquid supply paths 14. The nozzle plate 20 comprises a glass ceramic, a single crystal silicon substrate, or rustless steel having a thickness of, for example, 0.01 to 1 mm, and a linear expansion coefficient of, for example, 2.5 to 4.5 [×10⁻⁶/° C.] at 300° C. or below.

On the side of the passage-forming substrate 10 opposite to its opening surface, the elastic film 50 having a thickness, for example, of about 1.0 μm is formed, as described above. An insulation film 55 having a thickness, for example, of about 0.4 μm is formed on the elastic film 50. On the insulation film 55, a lower electrode film 60 with a thickness, for example, of about 0.2 μm, a piezoelectric layer 70 with a thickness, for example, of about 1.0 μm, and an upper electrode film 80 with a thickness, for example, of about 0.05 μm are formed in a laminated state by a process (to be described later) to constitute a piezoelectric element 300. The piezoelectric element 300 refers to a portion including the lower electrode film 60, the piezoelectric layer 70, and the upper electrode film 80. Generally, one of the electrodes of the piezoelectric element 300 is used as a common electrode, and the other electrode and the piezoelectric layer 70 are constructed for each pressure generating chamber 12 by patterning. A portion, which is composed of any one of the electrodes and the piezoelectric layer 70 that have been patterned, and which undergoes piezoelectric distortion upon application of voltage to both electrodes, is called a piezoelectric active portion. In the present embodiment, the lower electrode film 60 is used as the common electrode for the piezoelectric elements 300, while the upper electrode film 80 is used as an individual electrode of each piezoelectric element 300. However, there is no harm in reversing their usages for the convenience of a drive circuit or wiring. In either case, it follows that the piezoelectric active portion is formed for each pressure generating chamber. Herein, the piezoelectric element 300 and a vibration plate, where displacement occurs by a drive of the piezoelectric element 300, are referred to collectively as a piezoelectric actuator.

In the foregoing example, the lower electrode film 60 of the piezoelectric element 300, the elastic film 50, and the insulation film 55 act as the vibration plate. A lead electrode 90 extends as lead-out wiring led from a site near an end portion in the longitudinal direction of the upper electrode film 80 of the piezoelectric element 300 up to a site near an end portion of the pressure generating chamber 12 of the passage-forming substrate 10. The lead electrode 90 comprises, for example, gold (Au), or an adherent metal, such as titanium-tungsten (TiW), provided on the underside of the gold. The lead electrode 90 is electrically connected to a drive IC 110 (to be described later) via a bonding wire 120 through a through-hole 33.

The reservoir forming plate 30, which has the reservoir portion 32 constituting at least a part of the reservoir 100, is bonded via an adhesive agent 35 onto the passage-forming substrate 10 on which the above-described piezoelectric elements 300 have been formed. The reservoir portion 32, in the present embodiment, is formed so as to penetrate the reservoir forming plate 30 in its thickness direction and extend in the width direction of the pressure generating chambers 12. The reservoir portion 32, as described earlier, is brought into communication with the communicating portion 13 of the passage-forming substrate 10 to constitute the reservoir 100 which serves as the common liquid chamber for the respective pressure generating chambers 12.

In a region of the reservoir forming plate 30 opposed to the piezoelectric elements 300, there is provided a piezoelectric element holding portion 31 which has such a space as not to impede the movement of the piezoelectric elements 300. In a region of the reservoir forming plate 30 defined between the reservoir portion 32 and the piezoelectric element holding portion 31, the through-hole 33 is provided which penetrates the reservoir forming plate 30 in its thickness direction. The lead electrode 90, which is the lead-out wiring leading from each piezoelectric element 300, has an end and an adjacent area exposed in the through-hole 33. The material for the reservoir forming plate 30 of such a configuration is, for example, glass, a ceramic material, a metal, or a resin. Preferably, the reservoir forming plate 30 is formed of a material having nearly the same thermal expansion coefficient as that of the passage-forming substrate 10. In the present embodiment, the reservoir forming plate 30 is formed from a single crystal silicon substrate which is the same material as that for the passage-forming substrate 10.

The drive IC 110 for driving each piezoelectric element 300 is provided on the reservoir forming plate 30. One end of the bonding wire 120 is connected to each terminal portion 111 of the drive IC 110. The other end of the bonding wire 120 is connected to a terminal portion 90a of the lead electrode 90, which is a bonding pad, by a wire bonding method (its details to be described later). The wire diameter of the bonding wire 120 is preferably 20 to 30 μm and, in the present embodiment, the bonding wire 120 having a wire diameter, for example, of 25 μm and comprising gold (Au) is used.

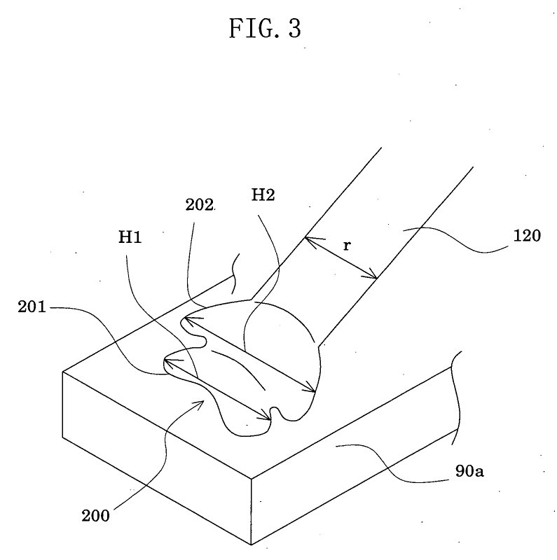

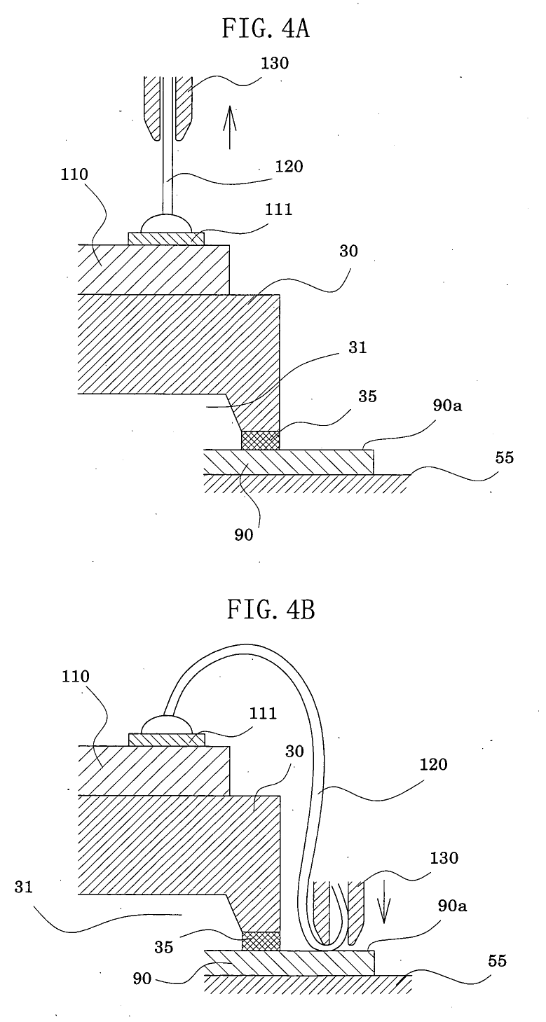

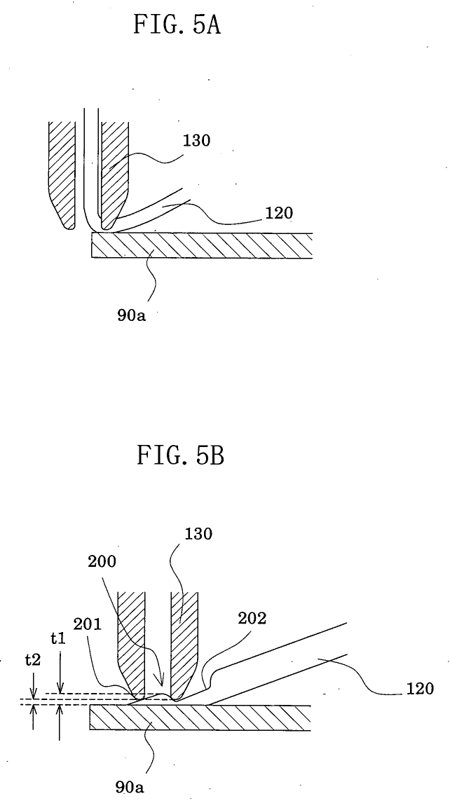

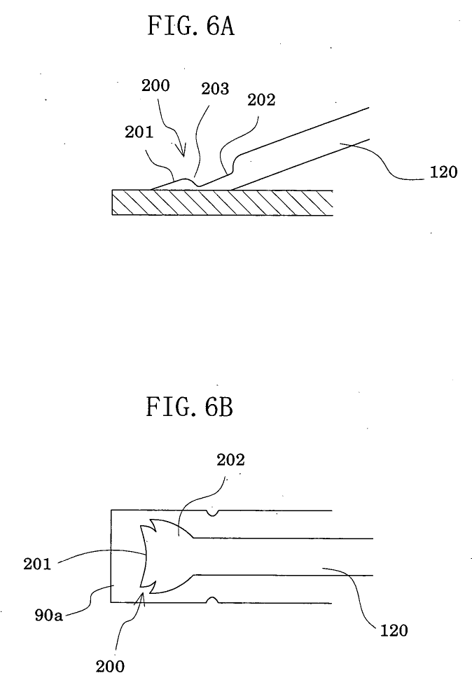

Explanations will be offered for a connecting structure (bonding structure) and a wire bonding method for the bonding wire 120 connected to the terminal portion 90a of the lead electrode 90, which is a bonding pad having at least a surface connected to the bonding wire 120 being formed from gold. FIG. 3 is a perspective view showing a connecting structure in wire bonding. FIGS. 4A and 4B are sectional views of essential parts of the liquid-jet head, showing the wire bonding method. FIGS. 5A and 5B are explanation drawings of steps in the wire bonding method. FIGS. 6A and 6B are external views of the connection sites of the bonding wire 120.

As shown in FIG. 3, a bonding site 200, which is a region where one end of the bonding wire 120 with a wire diameter r (for example, 25 μm) is connected to the terminal portion 90a of the lead electrode 90, is composed of a first connection site 201 (for temporary bonding) on the front end side, and a second connection site 202 (for main bonding) continuous with the first connection site 201. The bonding site 200 of the bonding wire 120 connected to the terminal portion 90a is formed by the wire bonding method (its details to be described later).

The second connection site 202 of the bonding site 200 is formed by applying ultrasonic waves of a larger amplitude than that for the first connection site 201, and the second connection site 202 has a higher tensile strength than that of the first connection site 201. The stitch width H2 of the second connection site 202 (maximum width of the second connection site 202) is rendered larger than the stitch width H1 of the first connection site 201 (maximum width of the first connection site 201). As shown in FIG. 5B, moreover, the thickness t2 of the second connection site 202 is rendered smaller than the thickness t1 of the first connection site 201.

Thus, the bonding strength between the bonding wire 120 and the terminal portion 90a can be increased. Furthermore, the bonding wire 120 and the terminal portion 90a can be bonded together firmly without being easily peeled away from each other.

Since the bonding strength of the bonding wire 120 connected to the terminal portion 90a as the bonding pad can be increased, the width of the bonding site 200 can be narrowed, the width of the terminal portion 90a can be narrowed, and the pitch between the terminal portion 90a and the adjacent terminal portion 90a can be decreased. As a result, the width and pitch of the lead electrodes 90 can be rendered small, so that the lead electrodes 90 can be disposed at high density, and the liquid-jet head can be downsized.

As shown in FIGS. 1 and 2A, 2B, a compliance plate 40 is bonded onto the reservoir forming plate 30. In a region of the compliance plate 40 opposed to the reservoir 100, a region other than a liquid introduction port 44 defines a flexible portion 43 which is formed to be thin in the thickness direction, and the reservoir 100 is sealed with the flexible portion 43. The flexible portion 43 imparts compliance to the interior of the reservoir 100.

The wire bonding method, which connects the terminal portion 111 of the drive IC 110 and the terminal portion 90a of the lead electrode 90, as bonding pads, by the bonding wire 120, will be described with reference to FIGS. 4A, 4B to FIGS. 6A, 6B.

As shown in FIG. 4A, the bonding wire 120 is held by being inserted through a capillary 130 constituting a wire bonding apparatus, and is connected to the terminal portion 111 of the drive IC 110 by ball bonding. This connecting method by ball bonding is performed by fusing the front end of the bonding wire 120 to form a ball, and pressing this ball against the terminal portion 111 of the drive IC 110.

Then, as shown in FIG. 4B, the bonding wire 120 is connected to the terminal portion 90a of the lead electrode 90 which is a bonding pad. At this time, the bonding wire 120 is connected by pressing the bonding wire 120 against the terminal portion 90a of the lead electrode 90 by means of the capillary 130 while heating the bonding wire 120 and applying ultrasonic waves.

That is, as shown in FIG. 5A and FIG. 6A, with the bonding wire 120 being heated, and ultrasonic waves being applied, the capillary 130 is pressed against the terminal portion 90a to connect the bonding wire 120 to the terminal portion 90a (temporary bonding) thereby forming the first connection site 201.

Then, as shown in FIG. 5B and FIG. 6B, the bonding wire 120 is pulled out. With the bonding wire 120 being heated, and ultrasonic waves being applied, the empty capillary 130 (tool) is pressed against the terminal portion 90a at a site continuous with the first connection site 201 to connect the bonding wire 120 to the terminal portion 90a (main bonding), thereby forming the second connection site 202.

According to the above embodiment, the capillary 130, which has become empty upon withdrawal of the bonding wire 120 after formation of the first connection site 201, is used as the tool for pressing for forming the second connection site 202. Thus, the first connection site 201 and the second connection site 202 can be formed by use of the single capillary 130. In forming the second connection site 202, it is also possible to use a dedicated tool having a shape and a size enough to perform main bonding, and there is no need to limit the tool for main bonding to the empty capillary 130.

Ultrasonic waves of a great amplitude are applied when the second connection site 202 is to be formed as compared with the first connection site 201. That is, when the first connection site 201 is to be formed, pressing by the capillary 130 with ultrasonic waves of a low amplitude being applied is performed to carry out temporary bonding. When the second connection site 202 is to be formed, pressing by the capillary 130 with ultrasonic waves of a high amplitude being applied is performed to carry out main bonding. Thus, wire bonding at a relatively lower temperature than the temperature of ordinary wire bonding is still capable of increasing bonding strength between the bonding wire 120 and the terminal portion 90a, because the second connection site 202 is formed by applying ultrasonic waves of a high amplitude.

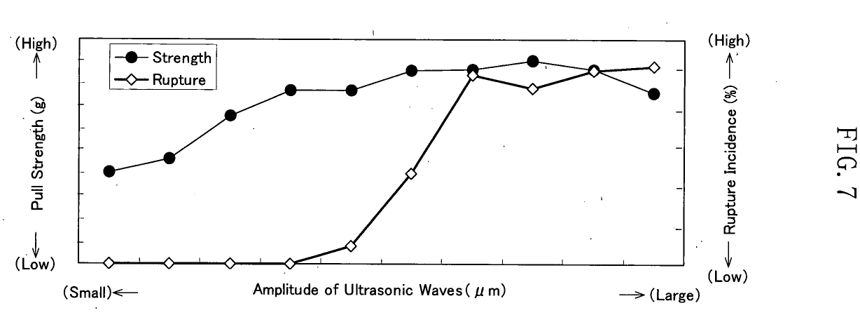

FIG. 7 shows the relationship between the amplitude of ultrasonic waves and both of tensile strength (pull strength in g) and rupture incidence (%). As shown in FIG. 7, as the amplitude of ultrasonic waves increases, the pull strength increases, and the rupture incidence also rises.

If the diameter of the capillary 130 is 66 mm and the diameter of the bonding wire 120 is 20 mm, for example, an adequate tensile strength of the order of 2.0 g to 4.0 g can be secured, and a rupture incidence of about 0% can be maintained, until the amplitude is of the order of 1.5 μm. If the diameter of the capillary 130 is 86 mm and the diameter of the bonding wire 120 is 30 mm, for example, an adequate tensile strength of the order of 4.0 g to 8.0 g can be secured, and a rupture incidence of about 0% can be maintained, until the amplitude is of the order of 3.0 μm.

Thus, the bonding site 200 composed of the first connection site 201 for temporary bonding and the second connection site 202 for main bonding, which is continuous with the first connection site 201, can be obtained by selecting, as appropriate, the amplitude of ultrasonic waves for forming the first connection site 201, and the amplitude of ultrasonic waves for forming the second connection site 202, in accordance with the diameter of the bonding wire 120. In the resulting bonding site 200, the second connection site 202 has higher tensile strength than the first connection site 201, and the stitch width of the second connection site 202 is larger than that of the first connection site 201. Furthermore, the bonding site 200 having the second connection site 202 thinner than the first connection site 201 can be obtained.

In the present embodiment, the terminal portion 111 of the drive IC 110 and the terminal portion 90a of the lead electrode 90 are electrically connected together by the bonding wire 120 connected by the above-described wire bonding method. However, the wire bonding method, and the connecting structure for the bonding wire, which have been described above, can be applied to all of the electrodes to be connected by the bonding wires of the liquid-jet head. Examples of the bonding wire other than that for the terminal portion 90a of the lead electrode 90 are a bonding wire for connecting the lower electrode film 60 and the drive IC 110, and a bonding wire for connecting a terminal portion of a wiring electrode, which is formed on the surface of the reservoir forming plate 30 bearing the drive IC 110, to the terminal portion of the drive IC 110, although such bonding wires are not shown.

The present embodiment illustrates the wire bonding method used on the actuator device, especially, the liquid-jet head, and the connecting structure of the bonding wire that has been formed by this method. However, the present invention is not limited to them, and can be applied to other devices using a bonding wire, such as semiconductor devices. It should be understood that such changes, substitutions and alterations can be made therein without departing from the spirit and scope of the invention as defined by the appended claims.

What is claimed is:

1. A bonding structure comprising:
a bonding wire;
a bonding pad; and
a bonding site where the bonding wire is connected to the bonding pad, and
wherein the bonding site is composed of a first connection site on a front end side, and a second connection site continuous with the first connection site.

2. The bonding structure according to claim 1, wherein the second connection site has a high tensile strength as compared with the first connection site.

3. The bonding structure according to claim 1, wherein the second connection site is connected by applying ultrasonic waves of a large amplitude to the second connection site as compared with the first connection site.

4. The bonding structure according to claim 1, wherein a stitch width of the second connection site is rendered large as compared with a stitch width of the first connection site.

5. The bonding structure according to claim 1, wherein a thickness of the second connection site is rendered small as compared with a thickness of the first connection site.

6. The bonding structure according to claim 1, wherein at least a surface of the bonding pad connected to the bonding wire comprises gold.

7. A wire bonding method for connecting a bonding wire to a bonding pad, comprising the steps of:
pressing a capillary against the bonding pad, while heating the bonding wire and applying ultrasonic waves, to connect the bonding wire to the bonding pad, thereby forming a first connection site; and
pressing a tool against the bonding pad at a site continuous with the first connection site, while heating the bonding wire and applying ultrasonic waves, to connect the bonding wire to the bonding pad, thereby forming a second connection site.

8. The wire bonding method according to claim 7, further comprising applying ultrasonic waves of a large amplitude at the second connection site as compared with the first connection site.

9. The wire bonding method according to claim 7, wherein the tool is the capillary through which the bonding wire has not been inserted.

10. An actuator device comprising:
a vibration plate provided on a surface of a substrate;
a plurality of piezoelectric elements each composed of a lower electrode, a piezoelectric layer, and an upper electrode provided via the vibration plate; and
bonding pads electrically connected to the piezoelectric elements, and having bonding wires connected thereto, and
wherein the bonding wires are connected to the bonding pads by the bonding structure of any one of claims 1 to 5.

11. The actuator device according to claim 10, further comprising lead-out wirings leading from the piezoelectric elements, and wherein front end portions of the lead-out wirings define the bonding pads.

12. The actuator device according to claim 10, wherein each of the bonding wires has one end connected to a terminal portion of a drive IC for driving the piezoelectric elements, and has another end connected to the bonding pad.

13. A liquid-jet head comprising:
the actuator device of any one of claims 10 to 12; and
a passage-forming substrate in which pressure generating chambers communicating with nozzle orifices are formed, and on a surface of which the actuator device is provided.
